(19) United States
(12) Patent Application Publication
(10) Pub. No.: US 2015/0287272 A1
(43) Pub. Date: Oct. 8, 2015

(54) SEATING APPARATUS FOR OPERATION OF A GAME OF CHANCE

(71) Applicant: Casino Game Maker, Inc., Las Vegas, NV (US)

(72) Inventor: Andrzej Surmacz, Las Vegas, NV (US)

(73) Assignee: CASINO GAME MAKER, INC., Las Vegas, NV (US)

(21) Appl. No.: 14/244,879

(22) Filed: Apr. 3, 2014

(51) Int. Cl. G07F 17/32

(52) U.S. Cl. CPC G07F 17/3216

(57) ABSTRACT

An apparatus is provided. The apparatus comprises a seating receptacle. Further, the apparatus comprises a data storage device positioned within the seating receptacle. The data storage device stores a plurality of games of chance. In addition, the apparatus comprises a data input device. The apparatus also comprises a processor positioned within the seating receptacle, the processor selecting a game of chance from the plurality of games of chance based upon an input received from the data input device and operating the game of chance for game play. Alternatively, a system comprises a plurality of seating receptacles.

### BACKGROUND

1. Field

This disclosure generally relates to the field of gaming. More particularly, the disclosure relates to gaming devices utilized to operate games of chance.

2. General Background

Casino game slot machines are typically provided throughout a casino gaming floor. Each casino game slot machine is typically dedicated to providing game play for a particular game of chance. Accordingly, a player that wants to play that particular game of chance has to search the casino gaming floor for that particular game of chance. As a typical casino gaming floor may have many slot machines, the player has to search through those slot machines for the particular game of chance.

Further, many players typically have a variety of different games of chance that they want to play at the casino. Accordingly, the players have to search for each game throughout the casino gaming floor. Such search may require travelling to distant portions of the casino gaming floor. Therefore, the player may have to go through a tiring and cumbersome process of meandering through a casino to find and play different casino games of chance.

Many players may not play the games they want to play because the process of finding casino games is so cumbersome. Accordingly, casinos do not obtain game revenue from customers that do not play certain games of chance. The current approach does not allow customers to easily find and play a variety of games of chance.

### SUMMARY

In one aspect of the disclosure, an apparatus is provided. The apparatus comprises a seating receptacle. Further, the apparatus comprises a data storage device positioned within the seating receptacle. The data storage device stores a plurality of games of chance. In addition, the apparatus comprises a data input device. The apparatus also comprises a processor positioned within the seating receptacle. The processor selects a game of chance from the plurality of games of chance based upon an input received from the data input device and operates the game of chance for game play.

In another aspect of the disclosure, a system is provided. The system comprises a plurality of seating receptacles. Further, the system comprises a plurality of data storage devices positioned within the plurality of seating receptacles. Each of the plurality of data storage devices stores a plurality of games of chance. In addition, the system comprises a plurality of data input devices. The system also comprises a plurality of processors positioned within the plurality of seating receptacles. Each of the plurality of processors selects a game of chance from the plurality of games of chance based upon an input received from each of the plurality of the data input devices and operates the game of chance for game play.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates a front view of a seating apparatus for operation of a game of chance.

FIG. 1B illustrates a back view of the seating apparatus illustrated in FIG. 1A.

FIG. 1C illustrates a side view of the seating apparatus illustrated in FIG. 1A.

FIG. 1D illustrates a top view of the seating apparatus illustrated in FIG. 1A.

FIG. 2 illustrates the components of the insert module illustrated in FIGS. 1C and 1D.

FIG. 3 illustrates a side view of a seating apparatus configuration in which the seating apparatus illustrated in FIG. 1 is situated in proximity to a display screen.

FIG. 4 illustrates a top view of a seating apparatus configuration.

FIG. 5 illustrates a multiple player gaming apparatus configuration.

FIG. 6 illustrates a system that may be positioned within the cabinet of the seating apparatus illustrated in FIG. 1B.

### DETAILED DESCRIPTION

A seating apparatus for operation of a game of chance is provided. An example of a seating apparatus is a gaming chair that has functionality built into the gaming chair for operation of a game of chance. Further, the seating apparatus allows a player to select from a variety of games of chance from the same seating apparatus. In contrast with a player playing a particular game of chance at a slot machine that is dedicated to operation of a particular game of chance and that player having to meander through the casino to find other slot machines dedicated to different games of chance, the player may have a dedicated seating apparatus to the player. The player may then utilize the seating apparatus to select a particular game of chance from a variety of games of chance and then play that game of chance. Upon completion of that game of chance, the player may continue to play the same game of chance or select a different game of chance from the same seating apparatus.

The seating apparatus for operation of a game of chance allows a player to enjoy a variety of game play experiences with different games of chance without having to meander throughout the casino gaming floor. Upon finding a seating apparatus within a casino gaming floor, the player is able to comfortably select and play a variety of different games of chance from the same seating apparatus.

Accordingly, the seating apparatus allows a casino to develop increased revenue from players wasting less time searching for various different games of chance. During the time period that a player may walk from dedicated slot machine to dedicated slot machine, the player at the seating apparatus may be playing different games of chance that provide revenue for a casino. The player may enjoy a more comfortable game play experience whereas the casino may develop increased revenue from the seating apparatus.

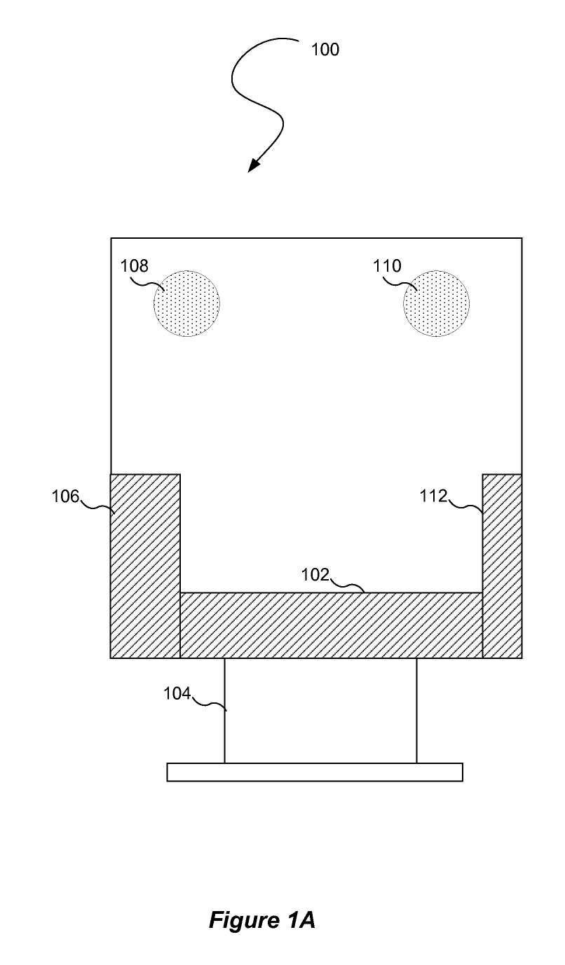

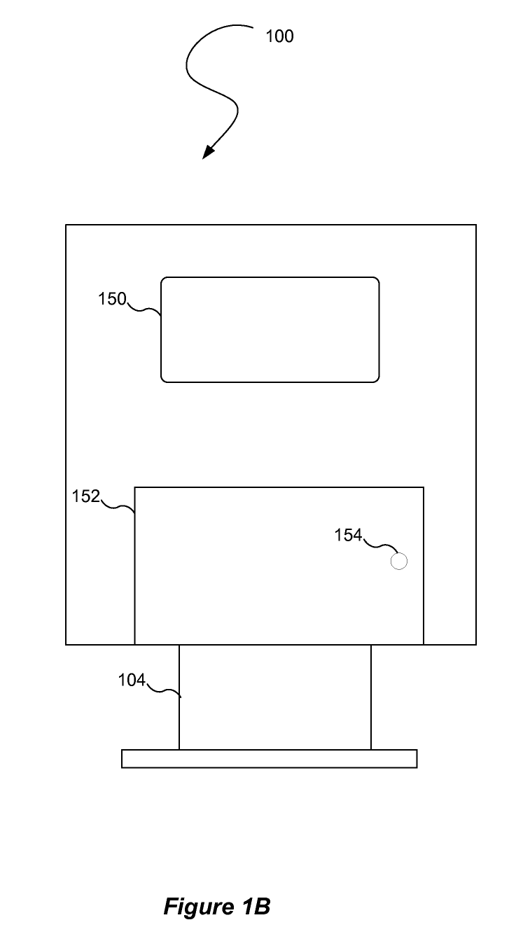

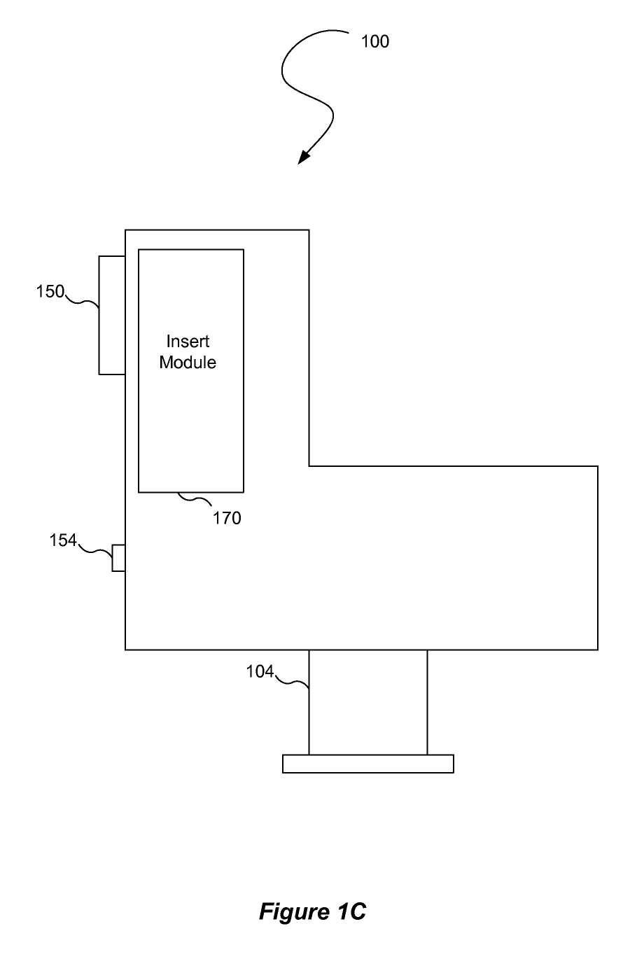

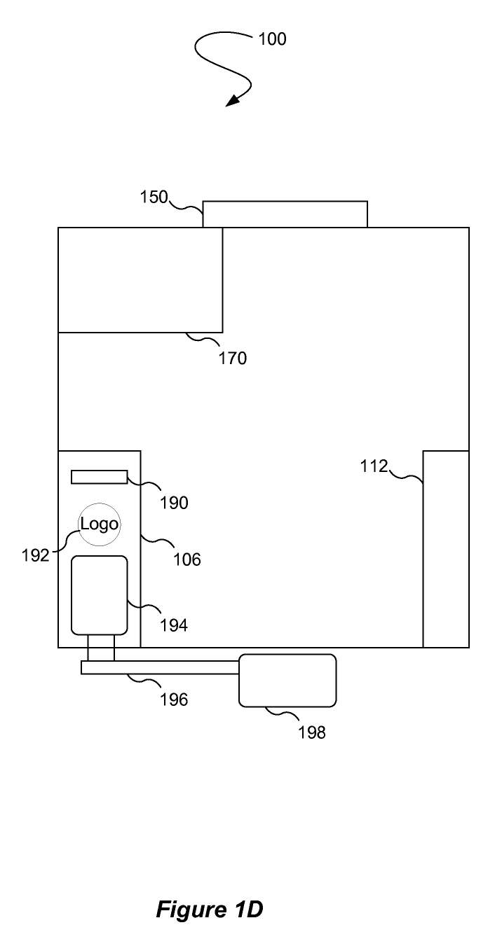

FIG. 1A illustrates a front view of a seating apparatus 100 for operation of a game of chance. The seating apparatus 100 may be utilized by a player to select a game of chance and operate that game of chance. In other words, the seating apparatus 100 has built in and integrated functionality within itself to allow the player to select a game of chance from a plurality of games of chance and operate the selected game of chance.

The seating apparatus 100 includes a seating receptacle 102 on which a player is situated. The seating receptacle 102 is operably connected to a stand 104. The stand 104 may be operably attached to the seating receptacle 102 via connecting means such as adhesives, fasteners, etc. Alternatively, the stand 104 may be integrated with the seating receptacle 102 as a portion of the seating receptacle 102. The stand 104 may be selected from a variety of types of mechanisms for maintaining elevation of the seating receptacle 102. For example, a plurality of legs may be utilized as the stand 104.

Further, the seating apparatus 100 may include an armrest 106. In one aspect of the disclosure, the armrest 106 may include a plurality of controls that allow the user to select a game of chance from a plurality of games of chance and/or operate game play for the selected game of chance. In another aspect, the user controls may be situated in another part of the seating apparatus 100 or may be operably connected to the seating apparatus 100.

In addition, the seating apparatus 100 may also include an additional armrest 112. The additional armrest 112 may or may not have any integrated control functionality.

In an aspect of the disclosure, the seating apparatus 100 may include a plurality of audio speakers 108 and 110 to provide sound effects associated with a particular game of chance during operation of the game of chance. The seating apparatus 100 controls the sound effects emanating from the plurality of audio speakers 108 and 110. For example, a processor situated in the seating apparatus 100 may determine which sound effects are to be played during operation of the game of chance. Further, the user may utilize controls integrated into the armrest 106 to adjust the sound of the audio effects emanating from the plurality of speakers 108 and 110.

Although the plurality of audio speakers is illustrated in FIG. 1, a single audio speaker or more than two audio spears may be utilized. Alternatively, the seating apparatus 100 may be utilized without any audio speakers. In another aspect of the disclosure, a vibration mechanism may be utilized for vibration effects based upon audio and/or events corresponding to the game of chance being played.

FIG. 1B illustrates a back view of the seating apparatus 100 illustrated in FIG. 1A. A display screen 150 may be positioned on the back of the seating apparatus 100. The display screen 150 may be utilized to provide a variety of functions. For example, the display screen 150 may be utilized to provide advertisements for particular games of chance, casino promotions, etc. The display screen 150 may display such data when a player is or not situated at the seating apparatus 100. Accordingly, other players may view the displayed data on the back of the seating apparatus 100 whether or not a player is playing a game of chance at the seating apparatus 100. The display screen 150 may also be utilized to provide information to casino employees that are fixing, maintaining, updating, etc. the seating apparatus 100.

The seating apparatus 100 also has a cabinet 152. The cabinet 152 may be locked by a lock 154 or other locking mechanism. The cabinet 152 may store the operational components of the seating apparatus 100 that allow a player to select a game of chance from a plurality of games of chance. For instance, the cabinet 152 may store a processor that selects and operates games of chance, a data storage device that stores games of chance, etc. For example, the processor or processors may be situated on a board or on a plurality of boards stored in the cabinet 152. As an example, the plurality of boards may be communication boards that communicate with a back end system, e.g., a board that communicates with a player tracking system, a board that communicates with a slot accounting system, a board that communicates with an accounting wagering system, a board that communicates with a ticket in and ticket out system, and/or any other communication board that may be utilized to interface with a network on a casino gaming floor. The processor or processors may be utilized to also provide for payment and player game tracking. For example, the processor or processors may operate payment mechanisms integrated into the seating apparatus 100 to accept payment for game play and may award or redeem player points for game play.

FIG. 1C illustrates a side view of the seating apparatus 100 illustrated in FIG. 1A. The seating apparatus 100 includes an insert module 170 that may be inserted into the seating apparatus 100. The insert module 170 provides various payment functionality. The insert module 170 may be inserted into the seating apparatus 100 through the top of the seating apparatus 100, the side of the seating apparatus 100, the back of the seating apparatus 100, the bottom of the seating apparatus 100, or through the cabinet 152.

FIG. 1D illustrates a top view of the seating apparatus 100 illustrated in FIG. 1A. In an aspect of the disclosure, the armrest 106 includes a card reader 190. For example, a player may have a casino player's card that the user may be able to utilize for payment of a game of chance. The player's card may also have points that may be redeemed by the player for game play of the game of chance. Further, points may be awarded to the player based upon an outcome of the game of chance.

In another aspect of the disclosure, the armrest 106 may have a logo 192. For example, the logo may be a casino logo. Alternatively, the logo 192 may be an advertiser's logo or an advertisement from an advertiser.

In yet another aspect of the disclosure, the armrest 106 may have a user control panel 194. The user control panel 194 may be a panel of buttons, a touch screen display screen, etc. A player may utilize the user control panel 194 to select a game of chance, operate a game of chance, request food and drink, etc.

In another aspect, a connecting mechanism 196 is operably connected to the armrest 106 and a display screen 198. The connecting mechanism 196 may be a swivel arm that is adjustable by the player. Alternatively, the connecting mechanism 196 may be fixed. The display screen 198 may be a tablet device, a touch screen display, an LCD display screen, etc. In an aspect of the disclosure, the player may operate the game of chance with the user control panel 190 and view the game of chance on the display screen 198. Alternatively, the player may operate the game of chance with the display screen 198 via touch screen inputs. The player may then view the game of chance on the display screen 198 or on a display screen situated in proximity to the seating apparatus 100.

In yet another aspect of the disclosure, additional or alternative input devices may be utilized for game selection and/or game operation. For example, a joystick may be operably connected, e.g., wired or wirelessly, to the seating apparatus 100 or integrated within the seating apparatus 100 for operation of the game of chance.

In another aspect of the disclosure, a gesture recognition system may be utilized to recognize inputs from the user. For example, a motion capture system utilizing an image capture device and an image recognition processor may be utilized to associate gestures provided by a motion of a hand or digit of the user in the air. The image recognition processor then associates particular gestures with particular commands. Such gesture recognition system may be utilized in conjunction with the user control panel 194 to provide the player with alternative input mechanisms or without the user control panel 194.

In yet another aspect of the disclosure, a voice recognition system may be utilized to recognize voice inputs form the user. For example, a voice recognition system utilizing a microphone and an audio recognition processor may be utilized to recognize audio commands in conjunction with or without the user control panel 194.

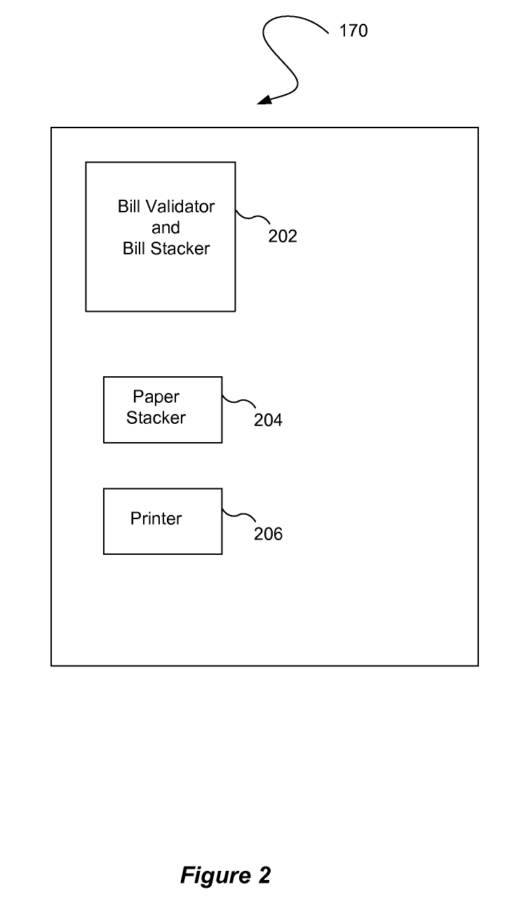

FIG. 2 illustrates the components of the insert module 170 illustrated in FIGS. 1C and 1D. The insert module 170 may include a bill validator and bill stacker 202, a paper stacker 204, and a printer 206. The card reader 190 illustrated in FIG. 1D allows the user to provide electronic payment via a card reader 190 that debits a player's account electronically. The insert module 170 allows a player to provide payment via cash, coins, or method other than a player's card. The insert module 170 then prints a receipt for the player. Accordingly, the seating apparatus 100 allows a player to provide payment for a game of chance through a variety of payment methods.

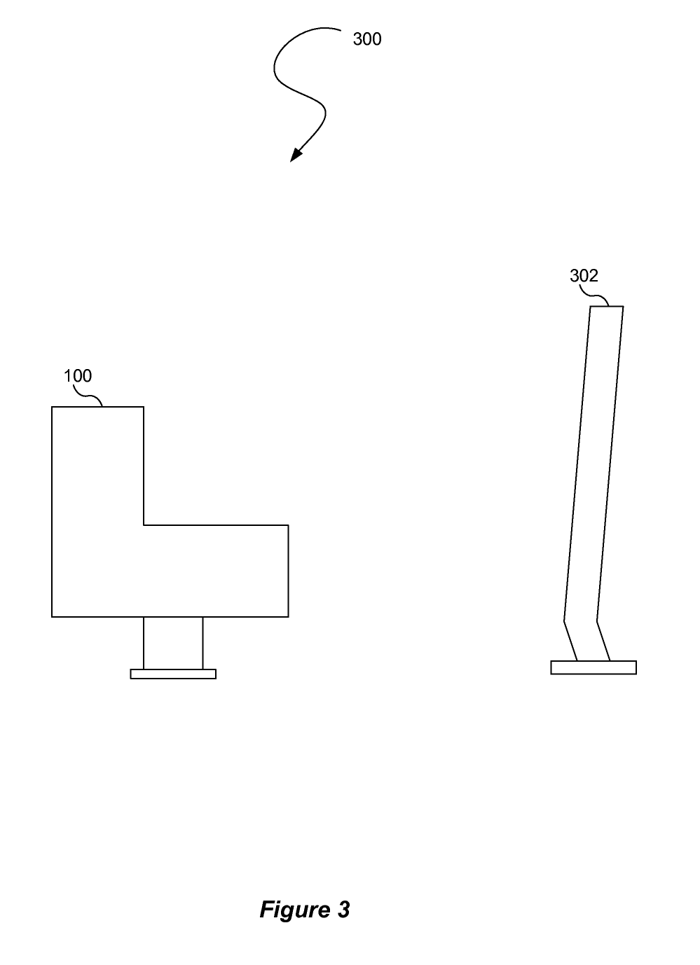

FIG. 3 illustrates a side view of a seating apparatus configuration 300 in which the seating apparatus 100 illustrated in FIG. 1 is situated in proximity to a display screen 302. The player selects and operates a game of chance from the seating apparatus 100, but views the game of chance at a display screen 302 that is distinct from the seating apparatus 100. The display screen 302 is in operable communication with the seating apparatus 100, e.g., wired or wireless communication. In an aspect of the disclosure, the display screen 302 may be a touch screen. The display screen 302 may be utilized to display data corresponding to the game of chance for the player situated at the seating apparatus 100. The display screen 302 may also be utilized to display advertisements. The advertisements may be adjusted to correspond to a particular game of chance. Accordingly, the advertisement may appear as a portion of the game of chance. The display screen 302 may also be utilized to display advertisements that do not correspond to the game of chance. The seating apparatus 100 may also be utilized to display advertisements that correspond to the game of chance or other types of advertisements that do not correspond to the game of chance. For example, the display screen 150 or the display screen 198 may be utilized to display advertisements.

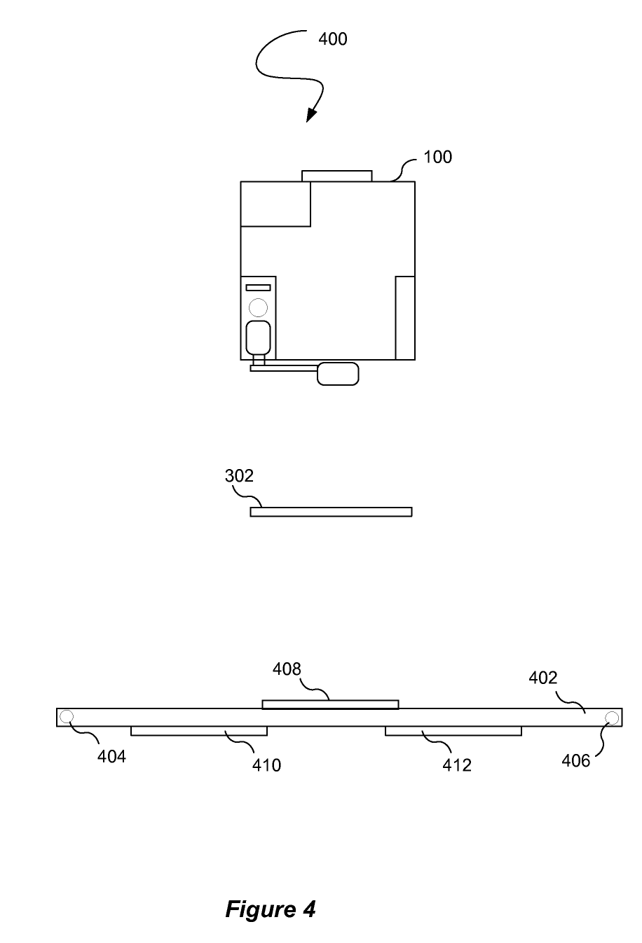

FIG. 4 illustrates a top view of a seating apparatus configuration 400. The seating apparatus 100 is situated in proximity to the display screen 302 illustrated in FIG. 3 and a wall 400. A plurality of display segments 408, 410, and 412 are situated in a rotation configuration. The display segments are adjusted via rollers 404 and 406 based upon a particular game of chance that is selected by the player for display on the display screen 302. For example, the display segment 408 is associated with a first game of chance, the display segment 410 is associated with a second game of chance, and the display segment 412 is associated with a third game of chance. Accordingly, the theme displayed on the wall may be adjusted to match the theme of the game of chance selected for display on the display screen 302.

In an aspect of the disclosure, the seating apparatus 100 is in operable communication with a controller that operates adjustment of the display segments 408, 410, and 412. For example, a processor positioned within the seating apparatus 100 may send a communication to a controller situated at the wall 402 to adjust the display segments 408 to a particular display segment based upon the selected game of chance. Alternatively, the processor positioned within the seating apparatus 100 may send a communication with stating the selected game of chance so that the processor positioned at the wall 402 may determine which wall segment to select.

In another aspect of the disclosure, the wall 402 may adjust display segments 408, 410, and 412 electronically instead of via rollers 404 and 406. As another alternative, the display segments 408, 410, and 412 may be adjusted manually. A variety of configurations may be utilized to adjust the display segments 408, 410, and 412.

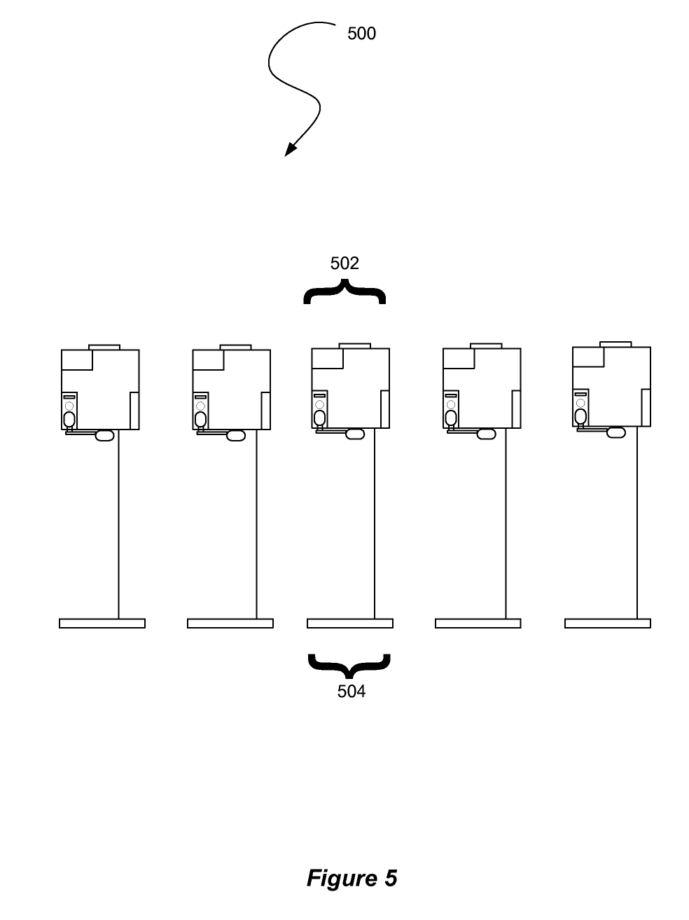

FIG. 5 illustrates a multiple player gaming apparatus configuration 500. The multiple gaming apparatus configuration 500 includes a plurality of game apparatuses 502. Each of the plurality of game apparatuses 502 is similar to the game apparatus 100 described in FIGS. 1A-1D. Further, the multiple gaming apparatus configuration 500 includes a plurality of display screens 504. Each of the plurality of display screens 504 is similar to the display screen 302 described in FIG. 3.

In an aspect of the disclosure, the multiple player gaming apparatus configuration 500 may be utilized to operate a multiple player game of chance. Each player may set at a gaming apparatus in the plurality of gaming apparatuses 502. Each of the display screens 504 displays a portion of the game of chance that is played by the players. For example, each display screen may display a reel of a casino game. Each player participates in the game of chance that is displayed by the plurality of display screens 504.

In another aspect of the disclosure, the multiple player gaming apparatus configuration 500 may be utilized to provide a game of chance in which each display screen is associated with a corresponding seating apparatus from the plurality of seating apparatuses. For example, a seating apparatus 502 corresponds to a display screen 504 in front of which the seating apparatus 502 is situated. The seating apparatus 502 is in operable communication with the display screen 504. Each player may play the multiple player game of chance based upon the particular game of chance data displayed at the corresponding display screen 504. In such configuration, the processor in each seating apparatus 502 may be utilized to determine a portion of the game played by all of the players. For example, each seating apparatus 502 may have a processor that is responsible for randomly determining a reel displayed at a corresponding display screen 504.

In yet another aspect of the disclosure, the multiple player gaming apparatus configuration 500 may be utilized to by multiple players to play independent games of chance. The games of chance may be the same or distinct based upon player selection. Alternatively, independent games may be initially played. An event may then activate a multiple player game, e.g., all the players press a spin button simultaneously, a player receives an outcome that provides a bonus session to another player to player a multiple player game, etc. The plurality of display screens 504 may then change to provide a display of the entire game.

In another aspect of the disclosure, the multiple player gaming apparatus configuration 500 may be utilized by a player to have multiple display screens 504 for the same of game of chance without playing with other players. For example, a player may be the only player that occupies a seating apparatus 502. The player may utilize the display screens 504 for operation of the game of chance. For instance, the player may utilize each of the display screens 504 as a reel in a game of chance.

The processes described herein may be implemented in a general, multi-purpose or single purpose processor. Such a processor will execute instructions, either at the assembly, compiled or machine-level, to perform the processes. Those instructions can be written following the description of the figures corresponding to the processes and stored or transmitted on a computer readable medium. The instructions may also be created using source code or any other known computer-aided design tool. A computer readable medium may be any medium or storage device capable of carrying those instructions and include a CD-ROM, DVD, magnetic or other optical disc, tape, silicon memory, e.g., removable, non-removable, volatile or non-volatile, packetized or non-packetized data through wireline or wireless transmissions locally or remotely through a network.

A computer is herein intended to include any device that has a general, multi-purpose or single purpose processor as described above. For example, a computer may be a kiosk, a tablet device, a smartphone, a set top box, cell phone, portable media player, etc.

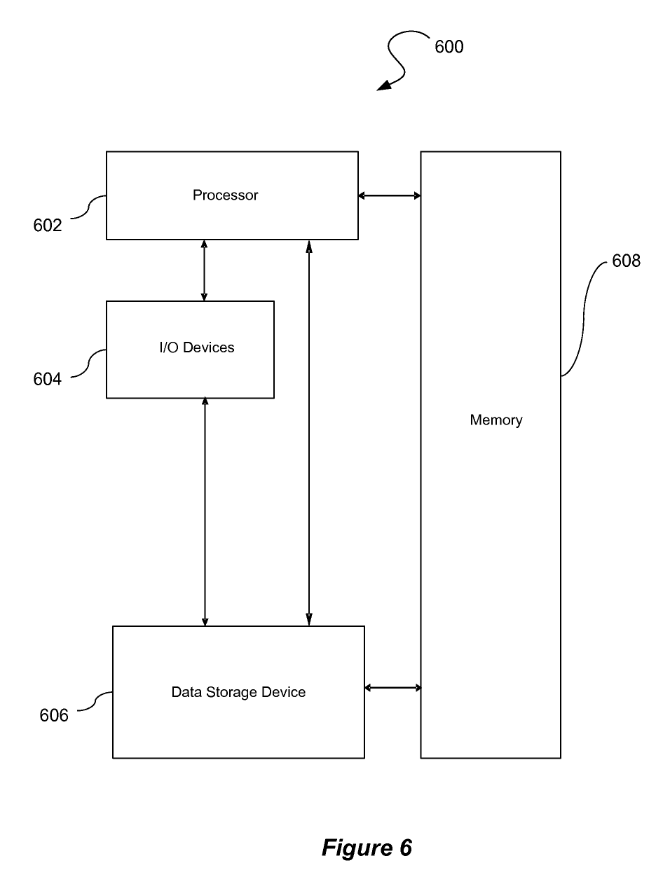

FIG. 6 illustrates a system 600 that may be positioned within the cabinet 152 of the seating apparatus 100 illustrated in FIG. 1B. The system 600 may be utilized to store a variety of games of chance, select a game of chance, accept payment for a game of chance, operate a game of chance, and display a game of chance. The system includes a processor 602, input/output (“I/O”) devices 604, a data storage device 606, and a memory 608. The data storage device 606 may store the plurality of games of chance. The processor 602 may retrieve a particular game of chance from the data storage device 606 based upon a user selection.

The seating apparatus for operation of a game of chance may be utilized for a game of chance that is operated for game play of a game based upon receipt of a wager and determination of a random outcome for a player prize. A game of chance is typically provided on a casino floor. The game of chance may be a casino game, lottery game, bingo game, etc. A game of chance will typically be operated with a random number generator or a manual random determination of an outcome. The game of chance may be a Class II or a Class III game. If the game of chance is a bingo game, the game of chance may or may not be limited to a finite quantity of bingo cards. In an aspect of the disclosure, the seating apparatus communicates with a casino network for operation of the game of chance. In another aspect of the disclosure, the casino game is played upon receipt of a wager corresponding to an outcome of the game of chance.

It is understood that the apparatuses, processes, and systems described herein may also be applied in other types of apparatuses, processes, and systems. Those skilled in the art will appreciate that the various adaptations and modifications of the embodiments of the apparatuses, processes, and systems described herein may be configured without departing from the scope and spirit of the present apparatuses, processes, and systems. Therefore, it is to be understood that, within the scope of the appended claims, the present apparatuses, processes, and systems may be practiced other than as specifically described herein.

I claim:

1. An apparatus comprising:
a seating receptacle;
a data storage device positioned within the seating receptacle, the data storage device storing a plurality of games of chance;
a data input device; and
a processor positioned within the seating receptacle, the processor selecting a game of chance from the plurality of games of chance based upon an input received from the data input device and operating the game of chance for game play.

2. The apparatus of claim 1, wherein the seating receptacle is a chair.

3. The apparatus of claim 1, wherein the data input device is operably connected to an armrest of the seating receptacle.

4. The apparatus of claim 1, wherein the data input device receives a game play input for operation of the game of chance.

5. The apparatus of claim 1, wherein the seating receptacle is positioned within a proximity to a display device that is distinct from the seating receptacle, the display device receiving game display data from the processor.

6. The apparatus of claim 1, wherein a display device is operably connected to the seating receptacle, the display device receiving game display data from the processor.

7. The apparatus of claim 1, further comprising an audio speaker that is positioned within the seating receptacle and provides an audio effect for the game of chance.

8. The apparatus of claim 1, further comprising an audio speaker that is positioned within the seating receptacle and provides an audio effect for the game of chance.

9. The apparatus of claim 1, wherein the data input device is a touch screen device.

10. The apparatus of claim 1, wherein the data input device receives audio data input.

11. The apparatus of claim 1, wherein the data input device determines the input based upon gesture recognition.

12. The apparatus of claim 1, wherein the seating receptacle is positioned within a proximity to a plurality of interchangeable wall segments that are automatically modified based upon the game of chance that is selected from the plurality of games of chance.

13. The apparatus of claim 1, further comprising a card reader positioned within the seating receptacle that accepts payment for participation in the game of chance.

14. A system comprising:
a plurality of seating receptacles;
a plurality of data storage devices positioned within the plurality of seating receptacles, each of the plurality of data storage devices storing a plurality of games of chance;
a plurality of data input devices; and
a plurality of processors positioned within the plurality of seating receptacles, each of the plurality of processors selecting a game of chance from the plurality of games of chance based upon an input received from each of the plurality of the data input devices and operating the game of chance for game play.

15. The system of claim 14, further comprising a display device that displays data for the game of chance based upon multiple users positioned at the plurality of seating receptacles selecting the game of chance.

16. The system of claim 14, further comprising a plurality of display devices that each display a distinct portion of data for the game of chance.

17. The system of claim 14, wherein the plurality of seating receptacles is arranged in a predetermined format.

18. The system of claim 14, wherein each of the plurality of processors is in operable communication with each other.

19. The system of claim 18, wherein the operable communication determines operation of the game of chance based upon multiple users selecting the game of chance.

20. The system of claim 18, wherein the operable communication determines display of the game of chance based upon multiple users selecting the game of chance.
